(19) United States
(12) Patent Application Publication
(10) Pub. No.: US 2011/0241841 A1
(43) Pub. Date: Oct. 6, 2011

(54) METHOD FOR CHECKING THE READING OF A MOBILE TRANSPONDER

(75) Inventor: Philippe Forin, Guyancourt (FR)

(73) Assignee: SIEMENS S.A.S., St. Denis (FR)

(21) Appl. No.: 13/139,416

(22) PCT Filed: Dec. 12, 2008
(86) PCT No.: PCT/FR08/01730

§ 371 Date: Jun. 13, 2011

(51) Int. Cl. H04Q 5/22

(52) U.S. Cl. 340/10.1

(57) ABSTRACT

A method for checking the reading of at least one mobile radiofrequency transponder moving relative to an antenna of a reader of the transponder, includes: at least one guaranteed reading area is defined around the antenna; at least one checking transponder is attached in the periphery of the guaranteed reading area in order to have the reading thereof periodically checked by the reader in addition to reading the mobile transponder. Examples of equipment for implementing the method are also provided.

The present invention relates to a method for checking the reading of at least one mobile radiofrequency transponder as claimed in the preamble of claim 1.

By means of transponder devices and mobile radiofrequency interrogators in relation with each other, it is difficult, in the presence of failures or electromagnetic interference, to guarantee that transponders are always correctly “seen” and identified by the interrogator with the level of safety required for the most critical safety functions, as may be the case for public transport, where a vehicle's onboard transponder must be read when said vehicle passes in front of a reader acting as an interrogator.

A current method aiming at overcoming this problem consists of linking a plurality of redundant onboard transponders and, where applicable, a plurality of redundant ground interrogators in order to guard against their failure, for example. Although the redundant linking of two (or more than two) transponders does not present a problem, in particular for known RFID tags, which are low-cost, redundancy of radiofrequency interrogators or readers in order to ensure safety presents two major inconveniences:
an economic problem due to their cost,
and, above all, interrogator redundancy does not always protect against electromagnetic interference. In fact, electromagnetic interference (for example an external electromagnetic field or a metal component close to the antenna) may prevent correct communication between the redundant interrogators and the transponders present in their vicinity. In this case, the data emitted by the transponders cannot be read accurately, even if a plurality of interrogators are linked redundantly.

An aim of the present invention is to propose a method of checking the reading of at least one mobile radiofrequency transponder moving relative to an antenna of a reader of said transponder, said check enabling detection of errors in the reading, particularly in the presence of internal or external interference occurring in the communication between the transponder and the reader. A particular aspect targeted by this aim is the ability to guarantee a level of safety required for critical safety applications for vehicles such as public transport vehicles (bus, trolley bus, tram, subway, train, etc.), and, in a more specific context, vehicles such as those guided by automated control systems, for example CBCT (Communication Based Train Control).

Another aim of the present invention is to provide simple equipment for effective implementation of said method of checking reading.

Such a method of checking reading according to the invention is thus retranscribed by means of the features of claim 1. Via claim 8, equipment for implementing said method is also given.

A set of subclaims also sets out advantages of the invention.

Principally, using a method of checking the reading of at least one mobile radiofrequency transponder moving relative to an antenna of a reader of said transponder, said method envisages that:
at least one guaranteed reading area is defined around the antenna,
at least one checking transponder is attached to the periphery of the guaranteed reading area, in order to have the reading thereof periodically checked by the reader in addition to a reading of the mobile transponder.

More specifically, the guaranteed reading area is defined so that, inside said area in the immediate vicinity of the fixed antenna, the link between the mobile transponder and the reader (via the antenna) is established as designed. When the transponder that is mobile relative to the antenna is present in this area, the correct reading of its data is thus guaranteed, whereas it becomes impossible to read the data from the checking transponder, because said data is inhibited by activation of data from the mobile transponder, the latter being temporarily closer to the antenna than the checking transponder.

Thus, if this reading process is not verified by the reader, a failure or fault stemming from a mobile transponder or one of the mobile transponders, or even the reader itself, may be advantageously detected.

Thereafter, a plurality of application variations for the method of checking reading according to the invention will be provided as well as equipment examples for implementation of said variations.

Examples of embodiment and application are provided using the figures described:

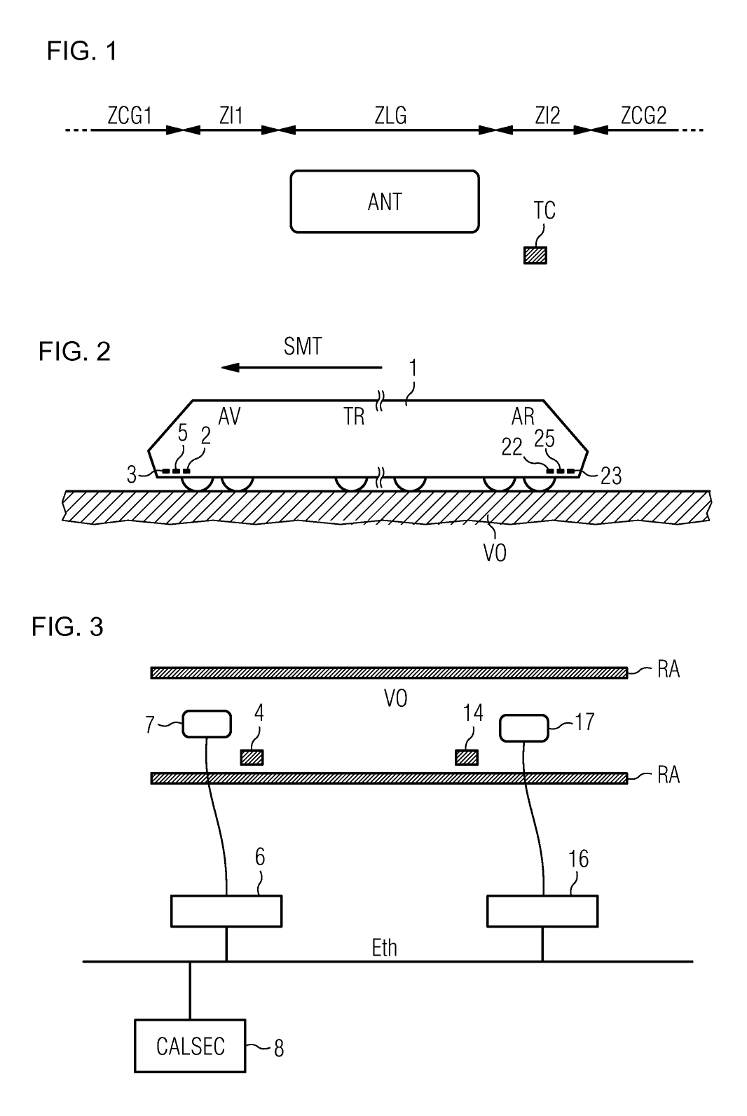

FIG. 1 Definition of areas including the guaranteed reading area and principle of the method according to the invention,

FIG. 2 Redundancy of mobile transponders suitable for the method according to the invention in the case of a rail vehicle,

FIG. 3 First equipment example for implementation of the method for checking the reading of onboard transponders according to the invention,

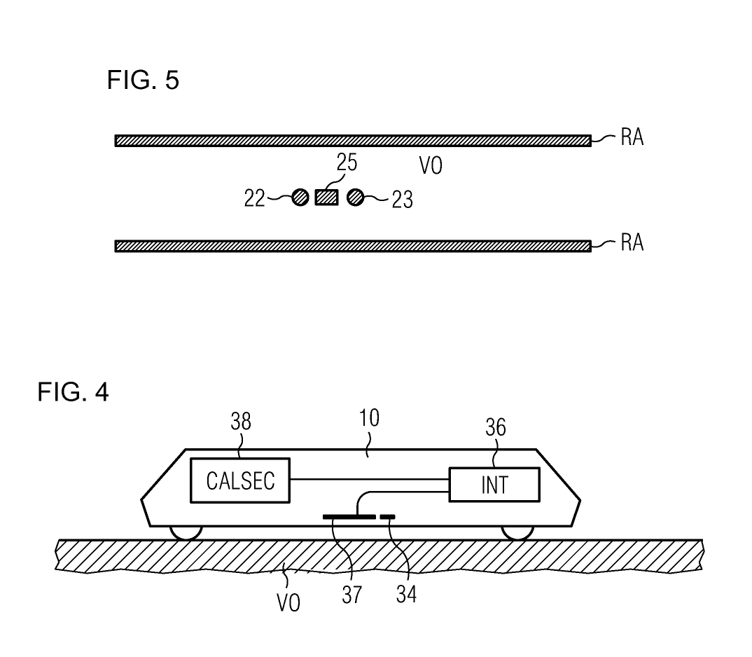

FIGS. 4, 5 Second equipment example for implementation of the method for checking the reading of transponders on the ground using an onboard reader according to the invention,

FIG. 1 is an illustration of the definition of the areas including the guaranteed reading area and the principle of the method according to the invention.

Said method of checking reading targets the reading of at least one mobile radiofrequency transponder moving relative to an antenna (ANT) of a reader (not represented) of said transponder. In the present case, the transponder moves.
At least one guaranteed reading area (ZLG) is defined within a limited perimeter around the antenna,
At least one checking transponder (TC) is attached to the periphery of the guaranteed reading area (ZLG) in order to be periodically read via the antenna by the reader in addition to a reading by a mobile transponder.

Said method is thus based on the positioning of the radiofrequency control transponder placed in proximity to the antenna of each reader, the latter periodically interrogating the checking transponder. The radiofrequency data read from the transponder by the readers or interrogators are transmitted to at least one safety computer connected to the interrogators.

The checking transponder(s) contain at least one identifier that differentiates them from mobile transponders to be read, in other words transponders carrying data the purpose of which is to be read correctly, the latter transponders being mobile relative to the interrogators.

The checking transponders have physical properties that are almost the same as those of mobile transponders, so that, if electromagnetic interference prevents an accurate reading of data from a mobile transponder that passes in front of an interrogator, the same interference also prevents accurate reading of data from the checking transponder.

The position of the checking transponder relative to the antenna of the interrogator is chosen so that:
its data is accurately read in normal circumstances, in other words without electromagnetic interference and in the absence of any other transponder(s) in the vicinity of the antenna;
when a mobile transponder is in the vicinity of an antenna in the guaranteed reading area (ZLG) envisaged for an accurate reading, the electromagnetic coupling between the antenna and the mobile transponder should be markedly better (˜10 to 20 dB) than the coupling between the antenna and the checking transponder: the data from the mobile transponder will therefore be accurately read, while the reading of data from the checking transponder becomes impossible.

These arrangements guarantee that, if the interrogator has accurately read or accurately reads the data from the checking transponder, it accurately reads the data from mobile transponders (that are free from faults) when they pass in front of the antenna.

More specifically, in the absence of a failure or of electromagnetic interference, three areas of vicinity can be defined for the antenna:
in the immediate vicinity of the antenna, the aforementioned first area, the guaranteed reading area (ZLG), inside which the link between the mobile transponder and the interrogator is established as designed. When a mobile transponder is present in this area, accurate reading of its data is guaranteed as a priority over the reading of data from the checking transponder, which becomes impossible;
around the guaranteed reading area, a second area, an area of uncertainty (ZI1, ZI2), where no reading of data from a mobile transponder in relation with the antenna is guaranteed. In general this is due to electromagnetic interference between the radiofrequency emissions from the mobile transponders and checking transponders (since they have similar physical properties);
outside the aforementioned guaranteed reading areas and areas of uncertainty, a third guaranteed checking area (ZCG1, ZCG2) for which, irrespective of the number of mobile transponders present in this area and if none of them is in one of the two other areas (ZLG, ZI1, ZI2), a single accurate reading of the data from the checking transponder is therefore guaranteed by the interrogator.

Principally, each interrogator (via its antenna) periodically emits a query request to which all transponders that receive it correctly must reply by transmitting their data. The interrogators retransmit the data received from the transponders to a safety computer, which periodically checks the validity of said data.

Thus a checking period is defined (linked to the reading of at least the checking transponder) which should be shorter than the minimum period of transit of a mobile transponder through the guaranteed reading area. In other words, the reader undergoes a periodic check, within a checking period shorter than the minimum time taken for the relative mobile transponder to pass through the guaranteed area.

If this condition is fulfilled, as long as the computer receives accurate data newly acquired from each interrogator during a period shorter than the minimum transit time, it can be advantageously guaranteed in safety that no operational mobile transponder has passed through the guaranteed reading area without being “seen” by the interrogator.

Should the opposite be true, if the time lapse since a last valid check by an interrogator exceeds said minimal duration of transit, the computer considers that an indeterminate number of potentially unidentified mobile transponders have passed in front of this interrogator.

An interrogation period is also defined (linked to the reader or the interrogator itself), which is ideally shorter than the aforementioned checking period. In other words, the reader emits query requests to the checking transponder during a period shorter than the checking period. If a transmission error tolerance is to be respected, involving a finite number of successive interrogations without a usable response, the interrogation period should be shorter than the checking period divided by this finite number.

In the event of failure of an interrogator, if an interrogator stops interrogating or periodically transmitting responses from mobile transponders or checking transponders to the computer, it is clear that safety is guaranteed by the previously described mechanism. The same goes for failures involving a break in the connection between an interrogator and the computer.

In the same way, failure of a checking transponder is protected, since safety is also guaranteed by the previously described mechanism, as it no longer supplies the periodically expected data to the computer.

Concerning failure of the mobile transponder or one of the mobile transponders, safety is preferably ensured by their redundancy: each mobile transponder can be at least duplicated so that the object (for example a train) that carries it cannot cross the guaranteed reading area (ZLG) without being “seen” by the reader and therefore by the computer. Two mobile transponders thus duplicated are also separated by a sufficient distance so that they do not cause mutual interference during reading. This aspect is shown in FIG. 2, where the redundancy of mobile transponders is illustrated for implementation of the method according to the invention in the case of a rail vehicle (1) such as a train (TR) or its cars moving in the direction of movement of the train (SMT) on a track (VO).

Thus, in this example, a mobile transponder (2), here installed on board a train (TR), is placed redundantly with at least one other mobile transponder (3) in its vicinity, which is of course also installed on board the train.

The basic method previously described functions correctly if the length of time taken by the mobile transponders to pass through the area of uncertainty (see FIG. 1) is always shorter than the checking period. This is not the case if the relative speed between transponders and interrogators is variable over a wide range. In an edge case in which a mobile transponder comes to a stop in an interrogator's area of uncertainty, it can happen that no further valid data from the transponders is transmitted by the interrogator to the computer because the mobile transponder and the checking transponder cause mutual interference.

In this case, it is possible to use transponders and interrogators according to a procedure known as multi-channel, either frequential (different frequencies for mobile transponders and checking transponders) or temporal (with different response times for mobile transponders and checking transponders). More precisely, at least one mobile transponder (2) and the checking transponder on the track (VO) are equipped with multiplex transmission with transmission channels that are separate from the reader. Each of the transmissions between the mobile transponder and the reader is therefore qualitatively free from interference.

The area of uncertainty is therefore eliminated, because there is no further mutual interference between mobile transponders and checking transponders.

Furthermore, redundancy of mobile transponders is facilitated: by allocating different channels to redundant mobile transponders, the latter no longer cause mutual interference, and it suffices to maintain a minimum separation distance between the two.

However, the safety level can prove to be a little lower than in the aforementioned basic method, because of the differences introduced between the two types of transponder: in certain situations, reading the checking transponders can be carried out correctly, while reading the mobile transponders can be disrupted. In the case of a frequency multi-channel procedure for example, it must not be overlooked that failure of the interrogator affects certain channels and not others, which could render accurate reading of the data from the checking transponder impossible, but not reading of the data from mobile transponders.

Thus, for more critical safety applications, the problem can be resolved by linking an additional transponder to each mobile transponder (or to each group of redundant mobile transponders). By allocating the same channel to additional mobile transponders as to checking transponders, the safety level of the basic method is resumed advantageously, while maintaining the advantages of the multi-channel process. This process can therefore be defined as “mixed”.

In summary, the method according to the invention can envisage, for a multi-channel process, that redundancy of the mobile transponder (2) is ensured by means of at least one other mobile transponder (3) which is adjacent thereto and has a separate communication channel from the mobile transponder (2) and from the channel of the checking transponder (TC—as per FIG. 1). However, the multi-channel process does not necessarily involve redundancy of the mobile transponder: in principle, a mobile transponder with a different channel from the checking transponder suffices, even if its benefit is limited (its failures are not detected without redundancy).

Lastly, in the context of a mixed procedure, the method according to the invention envisages that at least one additional mobile transponder (5) is added in the vicinity of at least one mobile transponder (2, 3), said additional transponder having a separate channel from said mobile transponder and identical to the checking transponder.

In order to illustrate the last points according to the example of FIG. 2, the latter therefore represents a vehicle (1) such as a train unit fitted with two groups of three RFID transponders using frequency multi-channels, with one group at the front (AV) of the train and the other group at the rear (AR). The “front” group comprises two redundant mobile transponders (2, 3) responding respectively on two channels (on a first and a second frequency f1 and f2, not diagramed) and an additional mobile transponder (5) responding on another supposed channel on a fourth frequency (f4, also not diagramed). The “rear” group comprises two redundant mobile transponders (22, 23) responding respectively on two channels aligned respectively on the second and third frequency (f2, f3, not diagramed) and an additional mobile transponder (25) responding on the fourth frequency channel (f4).

FIG. 3 represents a first example of equipment for implementation of the method of checking readings from onboard transponders according to the invention, for which a vehicle (not represented) fitted with transponders such as in FIG. 2 move on a section of the track (VO) such as a set of rails (RA), said track being fitted along its length with two interrogators (6, 16), each linked respectively to one of two antennas successively arranged on the ground (7, 17) for example between the rails (RA). Each of the antennas or by extension the interrogators is linked respectively to one of two checking transponders (4, 14) responding on the fourth frequency channel (f4) as per the example in FIG. 2. The interrogators are connected to a safety computer (8, CALSEC) by means of an Ethernet communication network (Eth).

By way of example, it is possible to present a nominal sequence of reading by one of the interrogators (6) without transponder error when the front of the train and its linked group of transponders (2, 3, 5) pass over the antenna (7) positioned on the ground between the rails:
1. The group of transponders (2, 3, 5) at the front (AV) of the train is still far from the antenna (7), and only the checking transponder (4) can be read by the latter.
2. The mobile transponder (3) enters the antenna's field: a reading of the mobile and checking transponders (3, 4) is then possible.
3. The additional mobile transponder (5) is in the area of uncertainty and mutual interference is caused by it and the checking transponder (4) on their common channel on the fourth frequency (f4): thus, only the mobile transponder (3) can be read.
4. The additional mobile transponder (5) arrives in the guaranteed reading area: thus, only the mobile transponder (3) and the additional mobile transponder (5) can be read.
5. The mobile transponder (3) leaves the antenna's field (7): only the mobile transponder (5) can be read.
6. The redundant mobile transponder (2) leaves the antenna's field (7): thus, only the mobile transponder (2) and the additional mobile transponder (5) can be read.
7. The additional transponder (5) has left its guaranteed reading area, and mutual interference is caused by it and the checking transponder (4) on their common channel on the fourth frequency (f4): thus, only the mobile transponder (2) can be read.
8. The additional transponder (5) has left the antenna's field (7), and its interference with the checking transponder (4) stops: thus, only the mobile transponder (2) and the checking transponder (4) can be read.
9. The mobile transponder (2) leaves the antenna's field: only the checking transponder (4) can be read.

It can be seen over this sequence of reading phases {4, 4+3, 3, 3+5, 5, 5+2, 2, 2+4, 4} that the process known as “mixed” allows:
consistent accurate reading of the data of at least one (onboard) transponder when a vehicle passes, irrespective of the speed at which the vehicle passes,
a guarantee of a minimum level of safety using an additional mobile transponder (5) and a checking transponder (4) responding on the same channel.

Said sequence, however, is not unique. For example, by bringing the mobile transponders (2, 3) even closer together, a sequence of reading phases can be obtained with the following shape: {4, 4+3, 4+3+2, 3+2, 3+2+5, 3+2, 4+3+2, 4+2, 4}, because these two mobile transponders (2, 3) transmit on different channels (without mutual interference) and enable dual channel readings with an adapted reader. This redundancy also increases the level of safety of the method of checking reading. Other sequences can be advantageously obtained by slightly adjusting the arrangement of the mobile transponders.

FIGS. 4 and 5 represent a symmetrical arrangement compared to the previous examples as per FIGS. 2 and 3, in that a second example of equipment for implementing the method of checking readings of ground transponders using an onboard reader as per the invention is illustrated.

The interrogator (36, INT), its antenna (37), their linked checking transponder (34) and the computer (38, CALSEC) are now on board the vehicle (10), for example arranged beneath the floor of the vehicle, while the transponders hitherto known as “mobile” (22, 23) and the additional mobile transponder (25) are placed on the ground, for example between the rails (RA) of the track.

It is therefore clear that this second example is analogically identical for an implementation of the method of checking reading according to the previously described invention, and presents the advantage that the mobile transponders are in fact mobile in relation to the readers and the checking transponder. The method therefore very advantageously presents a means of checking ground-vehicle readings and vehicle-ground readings with a high level of safety.

In summary, according to the last examples, the invention therefore advantageously envisages equipment for the implementation of the method of checking the reading of a mobile transponder moving relative to a transponder reader incorporating a computer connected to the reader and fitted with:
a signal input for at least one read signal from the mobile transponder and for at least one checking signal from a checking transponder, said signals being from a reader,
a module for processing said signals,
an output signal delivering data relating to the presence of the mobile transponder in the guaranteed reading area or the passage through said area of the mobile transponder, for example when it is on board a vehicle and passes in front of a fixed reader on the ground.

If the transponder known as “mobile” is on the ground, then the reader and its checking transponder are moving in relation to the ground, for example in that they are on board a vehicle.

The computer delivers a signal carrying two pieces of data from the pair comprising the mobile transponder and the checking transponder, using a bit pattern for vehicle absence or for identification of a vehicle that is present.

A plurality of readers can be arranged at the extremities of block sections and can deliver signals ideally used to check vehicle occupancy on said block section and/or check an instruction from a signaling light or from route actuators. They also provide safety redundancy in the event of a delay pending replacement of a defective reader.

1-10. (canceled)

11. A method of checking a reading of at least one mobile radiofrequency transponder moving relative to an antenna of a reader of the transponder, the method which comprises:
defining at least one guaranteed reading area around the antenna, the guaranteed reading area having a periphery; and
mounting at least one checking transponder at a periphery of the guaranteed reading area, and periodically checking a reading thereof with a reader of the checking transponder in addition to the reading of the at least one mobile radiofrequency transponder.

12. The method according to claim 11, which comprises subjecting the reader to a periodic check within a checking period that is shorter than a minimum time taken for the mobile transponder to pass through the guaranteed area.

13. The method according to claim 12, which comprises emitting with the reader query requests to the checking transponder during a period shorter than the checking period.

14. The method according to claim 11, which comprises placing a first mobile transponder redundantly with a second mobile transponder in a vicinity thereof.

15. The method according to claim 11, wherein the at least one mobile transponder and the checking transponder have multiplex transmission with separate channels from the reader.

16. The method according to claim 15, wherein the mobile transponder is redundantly mounted with at least one other mobile transponder in a vicinity thereof and having a separate transmission channel from a channel of the mobile transponder and from a channel of the checking transponder.

17. The method according to claim 15, which comprises adding at least one additional mobile transponder in the vicinity of the at least one mobile transponder, the at least one additional mobile transponder having a separate channel from the at least one mobile transponder and identical to a channel of the checking transponder.

18. A device for checking a reading of at least one mobile radiofrequency transponder moving relative to an antenna of a reader of the transponder, the device comprising:
a computer configured to implement the method according to claim 11, the computer having
a signal input for receiving at least one read signal from the at least one mobile transponder read by a reader and for receiving at least one checking signal from a checking transponder read by a reader;
a module for processing the at least one read signal and the at least one checking signal;
an output signal output delivering data relating to a presence inside, or passage through, a guaranteed reading area surrounding the antenna, of a vehicle carrying the at least one mobile transponder.

19. The device according to claim 18, wherein said computer is configured to deliver a signal carrying two parts of data from a pair comprising the mobile transponder and the checking transponder, using a bit pattern indicating an absence of the vehicle or an identification of a vehicle that is present.

20. The device according to claim 18, wherein the vehicle is a track-bound vehicle and a plurality of readers are arranged at extremes of block sections for delivering signals suitable to check for vehicle occupancy on a respective block section and/or to check for an instruction from a signaling light or from route actuators.
